(19) United States
(12) Patent Application Publication
(10) Pub. No.: US 2004/0173326 A1
(43) Pub. Date: Sep. 9, 2004

(54) Lifting gate

(76) Inventor: Frank Dittmer, Teichwolframsdorf (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,114

(22) PCT Filed: Jul. 19, 2002
(86) PCT No.: PCT/EP02/08083

(30) Foreign Application Priority Data
Aug. 4, 2001 (DE) 201 12 885.3

(51) Int. Cl. E05D 15/06

(52) U.S. Cl. 160/201

(57) ABSTRACT

The invention relates to a lifting gate comprised of a system of a multitude of horizontally extending lamellae, which can move inside a vertical guide, are connected in a radially articulated manner while resisting tension, and which are provided with hinge elements, and the lifting gate is further comprised of a drive device. According to the invention, at least some of the lamellae are mounted in a manner that enables them to be horizontally displaced with regard to the vertical guide and/or to the hinge elements and/or these lamellae have at least one, in essence, vertically extending predetermined rupture point so that forces acting essentially on the front of the gate are absorbed only by the lamellae and not by the actual articulations and guide elements.

### DESCRIPTION

The invention relates to a lifting gate according to the preamble of claim 1, comprised of a system of a multitude of horizontally extending lamellae, which can move inside a vertical guide, are connected in a radially articulated manner while resisting tension, and which are provided with hinge elements, and the lifting gate is further comprised of a drive device.

Lifting gates with lamellae or sectional gates for closing and opening gate openings especially of factory halls, storage halls or similar facilities under normal operating conditions are known state in the art. Such lamellae lifting gates serve the closure of halls in a safe, impervious, weather-resistant and wind-resistant manner and must very rapidly be movable from an opened position into a closed position and vice versa and, if possible, must operate over a long time period without malfunctions and with little noise and wear. Moreover, such lamellae lifting gates should be operative relatively undisturbed and largely free of damages in need of repair also under the influence of transverse forces beyond a normal load level, e.g. due to faulty operating conditions or external collision-like influences.

The lamellae armor forming the vertically extending gate closure is usually comprised of a number of individual lamellae arranged horizontally towards the gate plane and connected on both sides in a radially articulated manner while resisting tension with one strap hinge formed from a number of hinge elements, and being movable by means of rollers running in vertical guideways.

A lamellae lifting gate comprising strap hinges extending on both sides, which are rigidly and firmly mounted by means of screwed connections, is described in U.S. Pat. No. 2,092,534. A similar solution comprising strap hinges guided across rollers in guideways, on which the lamellae are fixed in a firm and unmovable manner, is disclosed in U.S. Pat. No. 2,827,115.

Lamellae stationarily placed upon hinge elements are described in German Patent Application DE 40 15 214 A1.

Accordingly, the state in the art is characterized by a connection of lamellae with hinge elements provided on both sides, said connection being firm and rigid and unmovable in the horizontal direction. Due to the given rigidity such an embodiment is advantageous in view of the stability, particularly under the influence of loads from wind pressure. It has the disadvantage, however, that the operation of the gate must be stopped for extensive repair works if, for example, damages were caused by a stacker vehicle.

In addition, a rigid attachment of lamellae on hinge elements is not sufficiently suited to absorb power components occurring transversely to the gate plane, which may be due to tolerances resulting from fabrication or assemblage or which may be due to thermal effects, with the consequence that a pertaining drive device becomes sluggish or is blocked in an undesired manner.

For the absorption of loads of the aforementioned kind, known lamellae lifting gates are exclusively based on the elasticity of the lamellae material and the dimensions of the lamellae cross-sections, absolutely regardless of the fact that any load will directly affect the firm and rigid link points between the lamellae and the strap hinge. In many cases an elastic reduction of forces and tensions is therefore impossible, which entails the danger of plastic deformations up to lasting malfunctions or a complete functional breakdown.

On the basis of the foregoing it is, therefore, the object of the invention to provide a lifting gate comprised of a system of a multitude of lamellae, which can move inside a vertical guide and which are provided with hinge elements, whereby said lifting gate resists, on the one hand, all common static and dynamic loads and whereby, on the other hand, a destruction of the lamellae or a functional breakdown of the entire gate as a result from undesired force effects are prevented, whereby at least, however, the expenditure of necessary repairs caused by irreversible damages to the gate are decreased.

The solution of the object of the invention is provided by a subject matter according to the features of patent claim 1, with the sub-claims comprising at least expedient embodiments and advanced developments.

According to the invention, no longer a firm and rigid connection between the lamellae and the strap hinges or hinge elements is assumed, but the basis is formed by a horizontally displaceable assembly which allows, over a large area, the destruction-free absorption especially of external transverse power components directed at the vertical gate plane.

Accordingly, at least some of the lamellae of the lifting gate and of the horizontally extending lamellae applied in accordance with the invention are mounted in a manner that enables them to be horizontally displaced with regard to the vertical guide and/or the hinge elements and/or the lamellae have at least one substantially vertically extending predetermined breaking point.

Forces acting on the lamellae essentially under an angle deviating from the opening and closing direction are absorbed by the elasticity of the lamellae material and the displaceability, whereby a destruction of the lateral guide elements will not take place even in the case of a plastic deformation of the lamellae, as the lamellae can slide out of the guide.

In the case where the lamellae have predetermined breaking points, a defined breaking takes place along said points without a destruction or damage in the portion of the link points, especially of the vertical guide of the gate.

If a gate is damaged in the above-described way, the exchange works are concentrated on the exchange of the lamellae, without requiring to repair or exchange the guide elements or the gate guide itself. Thus, it is possible not only to reduce the repairing expenses with regard to the material, but a reduction in the expenditure of time is also possible.

According to one embodiment of the invention it is assumed that not all of the gate lamellae are designed in accordance with the invention, but that only part of the lamellae is mounted in a horizontally displaceable manner and/or is provided with predetermined breaking points. Preferably said lamellae are those located, in the closed position of the gate, in such a height in which they are exposed especially to impact forces or forces acting on the front, e.g. caused by an entering or exiting vehicle, or are endangered by the same.

For the mounting in a horizontally displaceable manner the lamellae ends may comprise vertical slit-like guide portions provided on one side or on both sides, for accommodating a hinge element or, respectively, a corresponding lateral hinge element section.

Alternatively, it is possible with respect to the horizontally displaceable mounting that the lamellae ends be accommodated by a hollow body, which is open on one side and the inner contour of which corresponds to the shape of the respective lamellae end, with said hollow body forming a part of the hinge articulation or being connected with the same.

The hollow body accommodating the lamellae ends may also be provided on both sides, which is an advantage especially for gates having a larger width.

According to another embodiment of the invention the vertical guide may be constructed as a hollow profile rail having a continuous longitudinal groove or longitudinal slit, with guide pins having, for instance, a circumferential collar gliding in the profiled rail. The ends of the guide pins not accommodated in the hollow profile rail, i.e. the corresponding portions thereof, are movably fixed in horizontal fitting recesses in the respective lamellae ends, or in adapter components provided therein.

The guide pins may be provided with a catch for the respective end of the corresponding lamellae, in which they are accommodated. According to one embodiment the catch extends radially from the pin surface towards the outside.

According to the guide pin solution as described, a bending moment becomes effective when the lamellae are deformed as a result of an undesired force effect, which eventually causes the corresponding end of the lamellae to glide out of the guide pin. In the case of repair, merely the deformed lamellae have to be exchanged, whereby the guide pins and the vertical guide itself are normally not damaged.

According to another embodiment of the invention the previous segmented hinge elements, which are normally made of metal, are replaced by a continuous flexible strap hinge. In said strap hinge made of a highly elastic plastics material reinforcement bands are embedded, which may also be made of an electrically conductive material. In the latter case said conductive inserts may serve as sensors for signalizing that a certain degree of wear has been reached. In the case where—according to an embodiment—abrasion has reached such a degree that the conductor(s) is (are) bare, a contact to a runner or tension roller is effected and a circuit is closed, which releases a corresponding warning signal in an optical and/or acoustical manner.

The above-described flexible strap hinge serves to attach profiled bodies also for the horizontally movable accommodation of the lamellae ends. The lamellae ends include lateral recesses which correspond to the outer contour of the free end of the respective profiled body. According to this embodiment, too, it is possible to insert an adapter component between the lamellae end and the profiled body, thus allowing, if required, the retrofitting of already existing gate systems.

According to the above-described embodiment the profiled bodies project from the lateral recesses once deformation forces act on the respective lamellae, so that the same is subjected to a corresponding permanent deformation. An undesired load transmission to the hinge articulation and the additional mechanical elements serving the attachment of the latter is interrupted. Accordingly, damages are caused only to the easily exchangeable lamellae itself.

Distance surfaces directed to the winding-up side may be provided on the flexible strap hinge, which allow a noiseless winding-up of the lamellae and ensure that the lamellae do not touch each other during the winding-up process.

One embodiment of the invention will hereinafter be described in more detail by means of figures, wherein

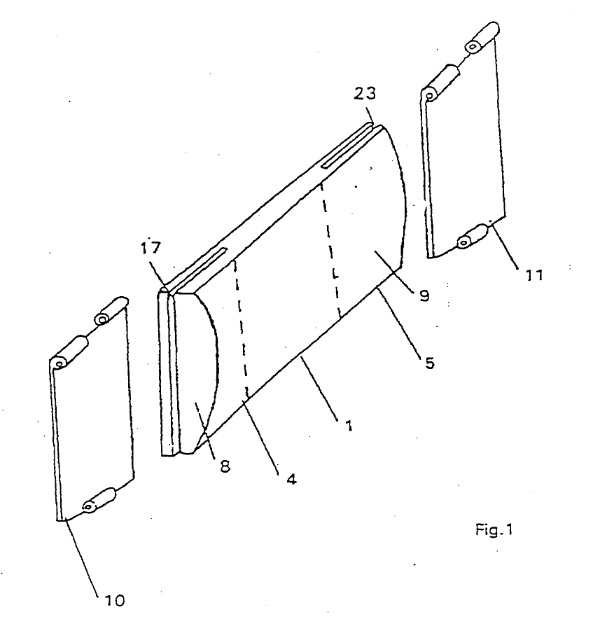

FIG. 1 shows a full body lamellae slit on both ends, with identically constructed hinge elements provided on both sides;

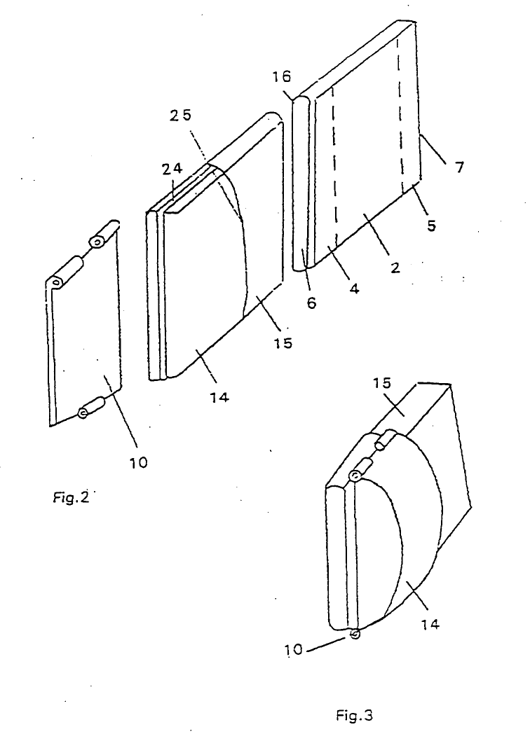

FIG. 2 shows a hollow body lamellae comprising an adapter component and a hinge element;

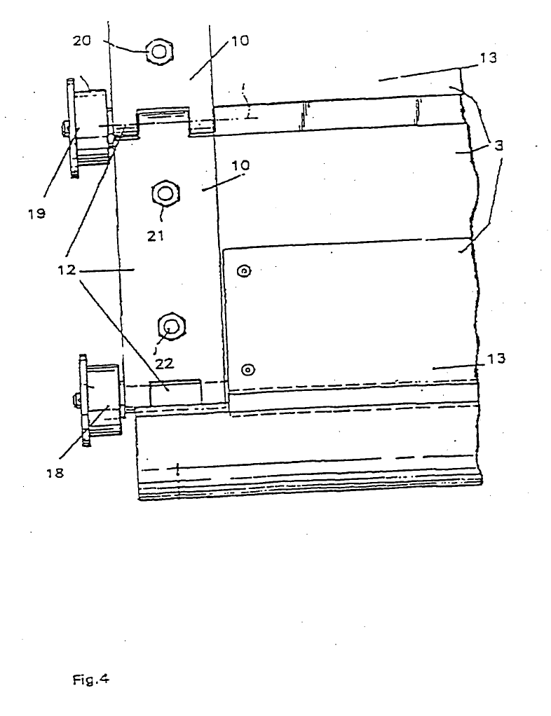

FIG. 3 shows an adapter element and a hinge element in a mounted state; and

FIG. 4 shows a lamellae armor according to the state in the art conventionally screw-connected with the strap hinge.

According to the embodiment, the invention describes a solution which allows a new, horizontally movable fixation and guidance of the lamellae of the lamellae armor within the strap hinges provided on both sides, with the aim to provide an essential prerequisite for the reduction of tensions resulting from operation and collisions, which cannot be achieved with the previously known rigid and unmovable, firm connections by means of vertical, preferably double-row pairs of screws or the like.

Furthermore, the principle of horizontally moving the lamellae as suggested provides for a prerequisite to obtain a load-dependent, sensor-controlled horizontal total release of the fixation and guidance of the lamellae and, thus, a complete independence of the lamellae armor versus overloads.

FIGS. 1 to 3 show lamellae 1, 2 of a lamellae armor 3 provided with lamellae portions 4, 5 on both ends, which—according to need—are designed as hollow body profiles 6, 7 or notch-like profiled full bodies 8, 9.

In response to the length of the lamellae, and thus to the width of the gate to be closed, either hollow body profiles 6, 7 or the aforementioned notch-like: profiled full bodies 8, 9 are used. The notches or grooves only serve to accommodate a hinge element 10, 11 or to indirectly fix and guide the lamellae 2 via a box profile 16 to an adapter element 15 of an adapter 25, which is likewise fixed and guided in the hinge elements 10, 11 in a lengthwise movable manner by means of the notch-like guide profile 24.

The hinge elements 10, 11 of the vertical strap hinges 12, which are of an identical construction and extend more or less laterally reversed on both sides, are dimensioned, with regard to their thickness, to correspond to both the notch-like guide profiles 17 of the lamellae 1 and the notch-like guide profiles 23, 24 of the adapter 25 such that a fixation and guidance of the lamellae 1, 2 extending transversely to the vertical gate plane relatively movable in a longitudinal direction, is possible.

Due to the given width of the hinge element and the corresponding depth of the grooves or notches 17 the required stiffness and resistance against loads from wind pressure is likewise guaranteed.

In comparison with the illustration according to FIG. 4, which shows a lamellae armor 3 with double-row screw connections 20, 21, 22 of the lamellae 13, and in which the strap hinges 11 and 12 provided on both sides as well as the vertical guide and guideways thereof and the guide rollers 18, 19 are outlined, the corresponding lamellae according to the embodiment projects out of the guide via the corresponding hinge element 10, 11 when acted upon by load, and the deformation forces are absorbed only by the lamellae itself, not however by the hinge element or the additional fastening elements. The rigid system according to FIG. 4 inevitably entails a deformation also of the strap hinges and/or the guide rollers, the provided axles and, respectively, the vertical guide itself, which is not illustrated in the drawing.

### List of Reference Numbers

1, 2 lamellae

3 lamellae armor

4, 5 lamellae portion

6, 7 hollow body profile

8, 9 notch-like profiled full body

10, 11 hinge element

12 strap hinge

13 lamellae

14, 15 adapter element

16 box profile

17 notch-like guide profile

18, 19 guide roller

20-22 screw connection

23, 24 notch-like guide profile

25 adapter

1. Lifting gate comprised of a system of a multitude of horizontally extending lamellae, which can move inside a vertical guide, are connected in a radially articulated manner while resisting tension, and which are provided with hinge elements, and the lifting gate is further comprised of a drive device, wherein at least some of the lamellae are mounted in a manner that enables them to be horizontally displaced with regard to the vertical guide and/or the hinge elements, and/or the lamellae have at least one substantially vertically extending predetermined breaking point.

2. The lifting gate according to claim 1, wherein the lamellae located from the lower end up to the middle in the closing direction of the gate are mounted to be horizontally displaceable and/or have at least one predetermined breaking point.

3. The lifting gate according to claim 1 or 2, wherein the lamellae ends comprise vertical slit-like guide portions for accommodating a hinge element or a hinge element section on one side or both sides so as to mount them in a horizontally displaceable manner.

4. The lifting gate according to claim 1 or 2, wherein, for mounting them in a horizontally displaced manner, the lamellae are accommodated by a hollow body open on one side and having an inner contour corresponding to the shape of the respective lamellae end, with the hollow body forming a part of the hinge element or being connected with the same.

5. The lifting gate according to claim 4, wherein the hollow bodies accommodating the lamellae ends are each provided on both sides.

6. The lifting gate according to claim 1, wherein the vertical guide is constructed as hollow profile rail having a continuous longitudinal groove or longitudinal slit, with guide pins gliding in the profiled rail and with opposite sections of the guide pins being movably fixed in horizontal fitting recesses in the respective lamellae ends or in an adapter body.

7. The lifting gate according to claim 6, wherein the guide pins comprise a catch for the respective end of the lamellae.

8. The lifting gate according to claim 7, wherein the catch extends radially from the upper pin surface towards the outside.

9. The lifting gate according to one of the preceding claims, wherein the hinge elements are formed of a flexible strap hinge.

10. The lifting gate according to claim 9, wherein profiled bodies also for the horizontally movable accommodation of the lamellae ends are provided on the strap hinge, with the lamellae ends or an adapter component having lateral recesses corresponding to the outer contour of the free end of the profiled body.

11. Lamellae for a lifting gate according to one of claims 1 to 10.

12. The lifting gate according to claim 1, wherein the lamellae (1, 2) of the lamellae armor (3) comprise lamellae portions (4, 5) on both ends, said lamellae portions (4, 5) being designed as closed hollow body profiles (6, 7) or notch-like profiled full bodies (8, 9) and being arranged to be movable in a limited horizontal manner within identically constructed strap hinges (12) extending on both sides and formed of the hinge elements (10, 11).

13. The lifting gate according to claim 12, wherein the lamellae portions (4, 5) on both ends of the lamellae (1, 2) are positively fixed on correspondingly profiled hinge elements (10, 11) of strap hinges (12) or adapter elements (14, 15) arranged on both sides, and are guided to be movable in a limited horizontal manner.

14. The lifting gate according to claim 12 or 13, wherein the full body profiles (7, 8) of the lamellae portions (4, 5) on both ends each comprise centrically extending notch-like guide profiles (17, 23) so as to be directly positively fixed on the correspondingly profiled hinge elements (10, 11) within the strap hinges (12) and guided to be movable in a limited horizontal manner.

15. The lifting gate according to claim 12 and 13, wherein the lamellae portions (4, 5) on both ends of the lamellae (1, 2) are indirectly positively fixed by correspondingly profiled adapter elements (14, 15) of identically constructed adapters (25) arranged on both sides and are guided to be movable in a limited horizontal manner, with the adapter elements (14, 15) of the adapters (25) being guided to be movable in a limited horizontal manner and fixed by means of a notch-like guide profile (24) on the correspondingly profiled hinge elements (10, 11), which are arranged on both sides, within the strap hinges (12).

16. The lifting gate according to claim 12, 13 and 15, wherein the hollow profiles (6, 7) of the lamellae portions (4, 5) on both ends are designed to be rectangular box profiles (16) so as to be indirectly positively fixed and guided to be movable in a limited horizontal manner via the correspondingly profiled adapter elements (15) within the profiled hinge elements (10, 11) corresponding to the notch-like guide profiles (24) of the adapter elements (14) within the strap hinges (12).

17. The lifting gate according to claim 12 to 16, wherein the lamellae (1, 2) are formed of a solid optically non-transparent metallic material such as light metal.

18. The lifting gate according to one of claims 12 to 16, wherein the lamellae (1, 2) are formed of a solid optically transparent or partly transparent non-metallic material such as plastics.
